(19) United States
(12) Patent Application Publication
(10) Pub. No.: US 2001/0034838 A1
(43) Pub. Date: Oct. 25, 2001

(54) Control program, device including the control program, method for creating the control program, and method for operating the control program

(76) Inventors: Motoshi Ito, Osaka (JP); Hiroshi Ueda, Osaka (JP); Shinji Sasaki, Osaka (JP)

Correspondence Address: Neil A. DuChez, Renner, Otto, Boisselle, & Sklar, L.L.P., 19th Floor, 1621 Euclid Avenue, Cleveland, OH, 44115, US

(21) Appl. No.: 09/754,018

(22) Filed: Jan. 3, 2001

(30) Foreign Application Priority Data
Jan. 14, 2000 (JP) 2000-005501

(51) Int. Cl. G06F 12/14; H04L 9/00

(52) U.S. Cl. 713/189; 713/190

(57) ABSTRACT

A control program for controlling an operation of a microprocessor includes a concealed program recoverable by a data scramble circuit and a non-concealed program.

### BACKGROUND OF THE INVENTION

1. Field of the Invention

The present invention relates to a control program, a device including the control program, a method for creating the control program, and a method for operating the control program.

2. Description of the Related Art

In general, what is generally called software or a program is classified into two categories: content such as music and video; and computer programs for controlling a central processing unit (referred to as a “CPU”) or a microprocessor unit (referred to as a “MPU”). In this specification, the term “content” is defined as content such as music and video, and the terms “program” and “software” are defined as computer programs unless otherwise specified.

Recently, content such as music and video is being digitized, and it has become more and more important to protect the copyright of such content. One technique to protect the copyright of such content is encryption. Content which is encrypted needs to be decrypted so as to be reproduced. In order to develop a reproduction apparatus for reproducing such encrypted content, it is required to conclude a license agreement with a cryptograph creator and to obtain a method for decryption and to embed this method for decryption into the reproduction apparatus with a protection means so as to prevent this method for decryption from being leaked to a third party.

In the case where a means for decryption is embedded into a device in the form of hardware, such as an LSI, only specialists in LSI production technology can analyze the algorithm in the LSI. However, in the case where decryption is performed by software, there is a danger that the cryptograph is analyzed by people who can decode the software algorithm by reverse assembly of the execution file of the software (so-called hacker) and the software is used illegally. In order to oppose the hackers, software which is difficult to be analyzed (tamper resistant programs) have been developed.

Still, a program which is difficult to be analyzed by only a particular software technique is not necessarily impossible to be analyzed by another software technique. The embedding of a means for decryption into a device in the form of hardware, such as an LSI, is disadvantageous in terms of development speed in consideration of the recent competition and also disadvantageous in terms of cost.

### SUMMARY OF THE INVENTION

According to one aspect of the invention, a control program for controlling an operation of a microprocessor includes a concealed program recoverable by a data scramble circuit and a non-concealed program.

In one embodiment of the invention, a recovered program recovered from the concealed program includes at least one function; and a relative address list indicating a relative address of the at least one function in the recovered program. The relative address list is provided at a prescribed location in the recovered program.

According to another aspect of the invention, a device includes a microprocessor; a program memory for storing a control program for controlling an operation of the microprocessor, the control program including a concealed program and a non-concealed program; a rewritable memory for storing a concealed program copied from the concealed program stored in the program memory; and a data scramble circuit for recovering the concealed program stored in the rewritable memory as a recovered program.

In one embodiment of the invention, the data scramble circuit acts as an error correction circuit.

In one embodiment of the invention, the recovered program includes at least one function; and a relative address list indicating a relative address of the at least one function in the recovered program. The relative address list is provided at a prescribed location in the recovered program.

According to still another aspect of the invention, a method for creating a control program includes a program descramble step of descrambling a portion of a control program by reverse scramble of a data scramble circuit in a device to be controlled, thereby creating a concealed program as a portion of the control program; and a program storing step of storing the control program including the concealed program in a program memory so that the control program controls an operation of a microprocessor in the device to be controlled.

In one embodiment of the invention, the program descramble step includes the steps of creating a non-concealed program; and synthesizing the concealed program and the non-concealed program into the control program.

According to still another aspect of the invention, a method for operating a control program includes a program copying step of copying a concealed program which is a portion of the control program from a program memory into a rewritable memory; a program recovery step of recovering the concealed program copied by the program copying step as a recovered program by a data scramble circuit; and a program execution step of executing a non-concealed program included in the control program and the recovered program.

In one embodiment of the invention, the method for operating a control program further includes a program erasure step of erasing the recovered program from the rewritable memory.

Thus, the invention described herein makes possible the advantages of providing a control program including a program to be concealed which is implemented partially by hardware and partially by software, a device including the control program, a method for creating the control program, and a method for operating the control program.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating a structure of a device according to an example of the present invention;

FIG. 2 is a circuit diagram illustrating an example of a data scramble circuit of the device shown in FIG. 1;

FIG. 3 is a flowchart illustrating a method for creating an execution format of a control program including a concealed program;

FIG. 4 is a flowchart illustrating a method for executing an instruction concealed in the concealed program created by the method shown in FIG. 3;

FIG. 5A is a block diagram of the device shown in FIG. 1 illustrating a program area in a program copying process;

FIG. 5B is a block diagram of the device shown in FIG. 1 illustrating a program area in a program recovery process;

FIG. 5C is a block diagram of the device shown in FIG. 1 illustrating a program area in a program erasure process;

FIG. 6 is a diagram illustrating a structure of a recovered program recovered from the concealed program by the method shown in FIG. 4; and

FIG. 7 is a diagram illustrating an address space of the device shown in FIG. 1.

### DESCRIPTION OF THE EMBODIMENTS

Hereinafter, the present invention will be described by way of illustrative examples with reference to the accompanying drawings.

The term “program” is defined as a control program unless otherwise specified. A control program operates a microprocessor based on an instruction (i.e., the control program controls the operation of the microprocessor), whereas a general content program is read based on an instruction from the microprocessor.

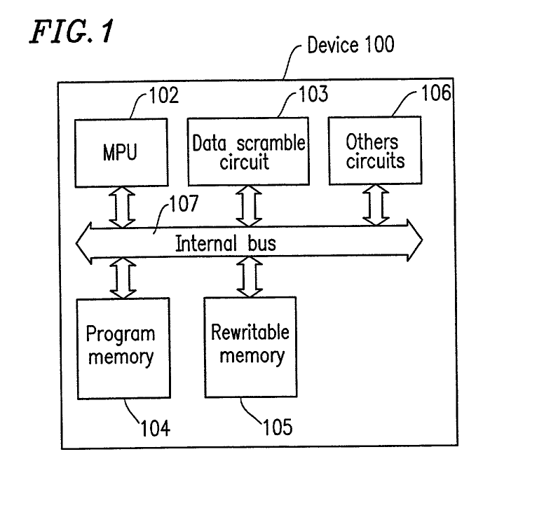

FIG. 1 is a block diagram illustrating a structure of a device 100 according to an example of the present invention. The device 100 includes a non-volatile program memory 104 for storing a control program, a microprocessor unit (MPU) 102 for controlling the device 100 in accordance with the control program stored in the program memory 104, a rewritable memory 105 for temporarily storing work data or the like of the MPU 102, a data scramble circuit 103 for reversibly scrambling data, other circuits 106, and an internal bus 107 for connecting these components. As the program memory 104, a reproduction only memory, a one time ROM, or a flash memory can be used. As the rewritable memory 105, a static memory which does not require an operation for holding data, or a dynamic memory which requires an operation for holding data can be used. Specifically, a DRAM can be used as the rewritable memory 105. When the device 100 is an information storing device, a data error correction circuit can be provided in the device 100 as one of the other circuits 106.

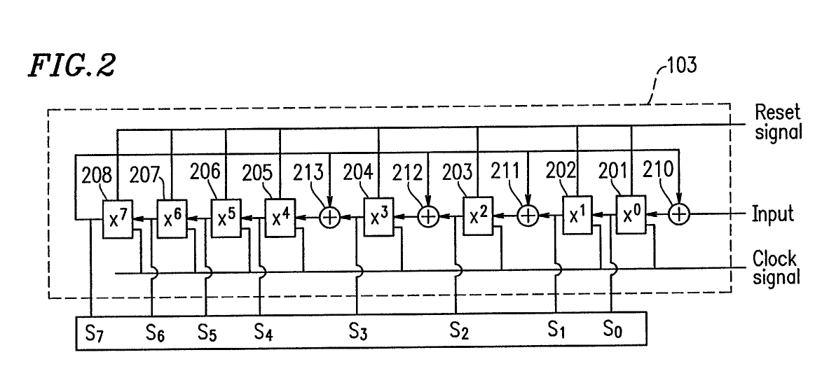

FIG. 2 is a circuit configuration illustrating an example of the data scramble circuit 103. The data scramble circuit 103 shown in FIG. 2 is a shift register including one-bit flip-flops 201 through 208 connected in series. One-bit exclusive-ORs 210, 211, 212 and 213 are respectively provided between an input and the flip-flop 201, between the flip-flops 202 and 203, between the flip-flops 203 and 204, and between the flip-flops 204 and 205. A signal from the flip-flop 208 is input to the exclusive-ORs 210, 211, 212 and 213. The flip-flops 201 through 208 are each connected to a reset signal line and a clock signal line. A reset signal resets the value held by each of the flip-flops 201 through 208. By one cycle of clock signals, the values held by the flip-flops 201 through 207 are shifted to the left by one bit, and the value held by the flip-flop 208 is input to the exclusive-ORs 210, 211, 212 and 213. This structure represents an 8-order primitive polynomial used in error correction theory, i.e., P(x)=x⁸+x⁴+x³+x²+1.

After the values of the flip-flops 201 through 208 are reset to 0 by the reset signal, a first clock is sent to each of the flip-flops 201 through 208 with the input signal being 1. Then, the following clocks are sent with the input signal being 0. Now, a data stream which is output clock-by-clock in this manner will be described. By the first clock, the output of the flip-flop 201 (represented by x⁰) is set to 1. By hexadecimal notation, the data stream which is output clock-by-clock is represented as 01, 02, 04, 08, 10, 20, 40, 80, 1D, 3A, . . . , 8E, 01, . . . . One cycle includes 255 (=2⁸−1) clocks. By adding 00 to the 256th clock of the output data stream, a reversible 8-bit data scramble is performed. By hexadecimal notation, the data scramble is represented as 00 into 01, 01 into 02, 02 into 04, 03 into 08, . . . , FE into 8E, and FF into 00. The reverse data scramble is represented as 00 into FF, 01 into 00, 02 into 01, 03 into 19, . . . , FE into 58, and FF into AF. The above-mentioned data scramble and reverse data scramble is merely illustrative, and any circuit which can perform a reversible data scramble can be used as the data scramble circuit 103. In the case where the device includes an error correction circuit, the error correction circuit has such a reversible data scramble function and thus the error correction circuit can be used as the data scramble circuit.

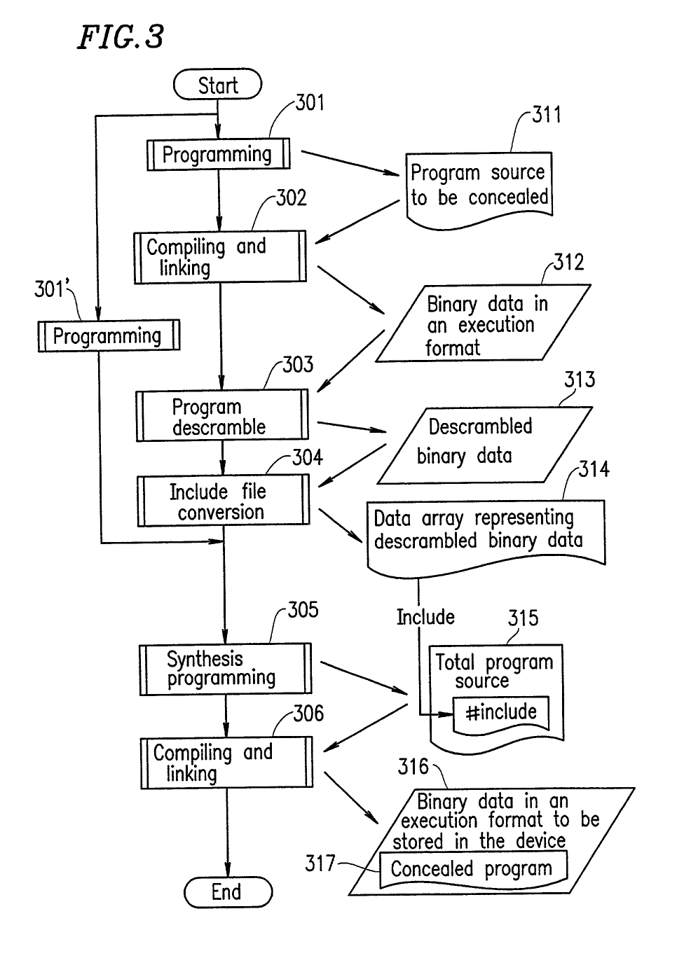

FIG. 3 is a flowchart illustrating a method for creating an execution format of a control program including a concealed program. In this specification, a concealed program is a program which cannot be analyzed by software processing, such as, for example, reverse assembly. A concealed program, as it is, cannot cause the MPU 102 (FIG. 1) to perform a desired operation. In this specification, programs in the control program other than the concealed program are defined as non-concealed programs.

Herein, the term “descramble” is defined as processing of creating a concealed program, and the term “recovery” is defined as processing of recovering the concealed program as an operable program. The data scramble described above can correspond to the descramble processing, and the reverse data scramble also described above can correspond to the recovery processing; or alternatively, the data scramble described above can correspond to the recovery processing, and the reverse data scramble also described above can correspond to the descramble processing.

In step 301, a control procedure to be concealed is programmed, thereby creating a program source 311, which is the subject of concealment (i.e., that which is to become a concealed program).

In step 302, the program source 311 is compiled and linked, thereby creating binary data 312 in an execution format.

In step 303, the binary data 312 in the execution format is processed according to the above-described data descramble, thereby creating descrambled binary data 313. The data scramble circuit 103 can perform a reversible data scramble.

In step 304, the descrambled binary data 313 is converted into a data array 314 in a program source format (for example, an include file format having a char-type array representation of the C language as its content). The conversion of the binary data 313 is performed so that the descrambled binary data 313 is easily incorporated into other program sources.

In step 305, the'data array 314 and another control procedure which is not the subject of concealment are synthesized into a total program source 315. The another control procedure which is not the subject of concealment is prepared after being programmed in step 301′ instead of steps 301 through 304.

In step 306, the total program source 315 is compiled and linked, thereby creating a binary data 316 in an execution format to be stored in the program memory 104 in the device 100 (FIG. 1). Here, a concealed program 317 corresponding to the program source 311 is generated as a portion of the binary data 316, and the concealed program 317 cannot be executed unless being recovered.

The binary data 316 can be written in the program memory 104 before shipment. Alternatively, the latest version of the binary data 316 can be distributed via the internet for updating the program memory using a flash memory, which is found on a motherboard of recent personal computers. The concealed control procedure (concealed program 317) in the binary data 316 created as described above cannot be analyzed even by reverse assembly or any other technique without the scramble algorithm.

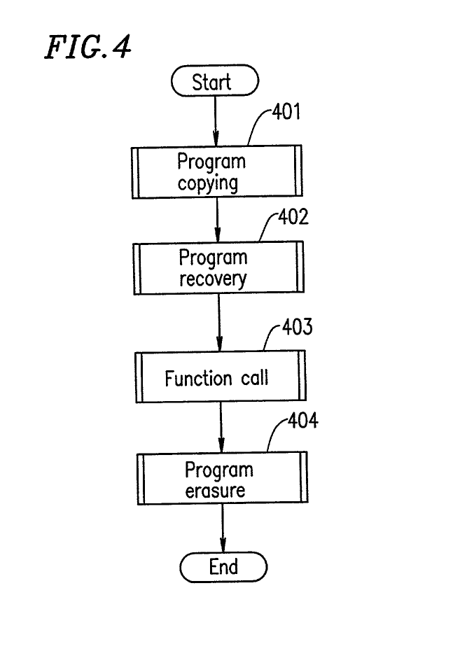

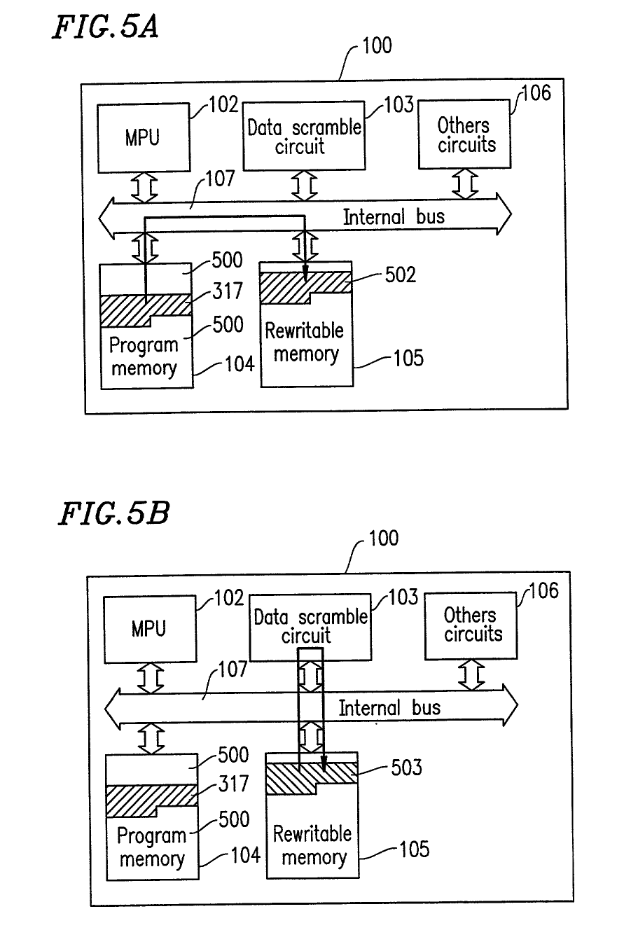

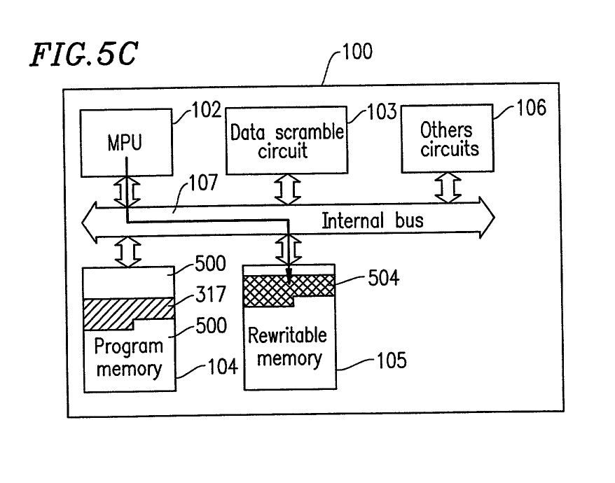

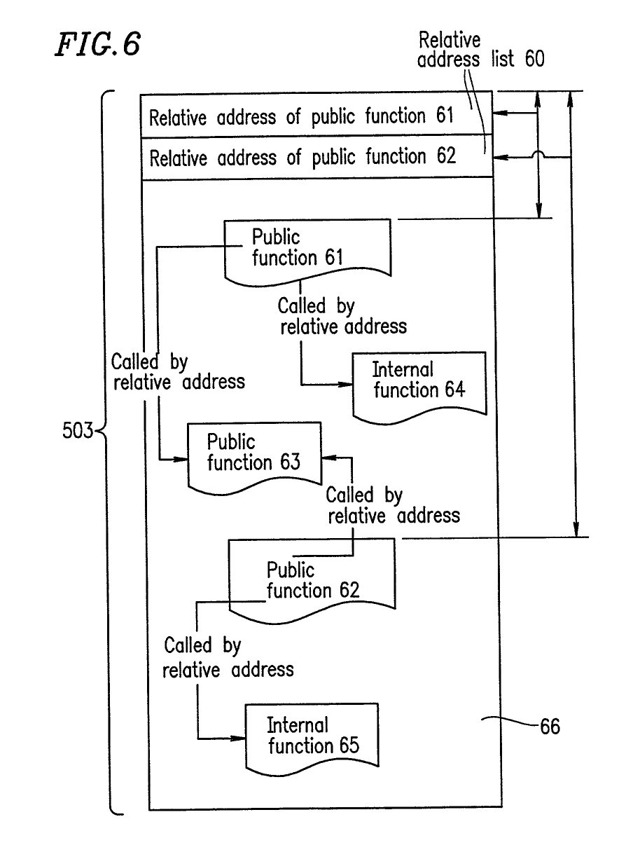

FIG. 4 is a flowchart illustrating a method for executing an instruction concealed in the concealed program 317 (FIG. 3). FIG. 5A is a block diagram of the device 100 showing a program area in a program copying process, FIG. 5B is a block diagram of the device 100 showing a program area in a program recovery process, and FIG. 5C is a block diagram of the device 100 showing a program area in a program erasure process.

With reference to FIGS. 4, 5A, 5B and 5C, a method for executing an instruction concealed in the concealed program 317 (FIG. 3) will be described.

In step 401, as shown in FIG. 5A, the concealed program 317 in the control program stored in the program memory 104 is copied into the rewritable memory 105, thereby creating a copied program 502. The content of the copied program 502 is identical with that of the concealed program 317.

In step 402, as shown in FIG. 5B, the copied program 502 in the rewritable memory 105 is recovered as a recovered program 503 using the data scramble circuit 103.

In step 403, the MPU 102 calls a function (also referred to as a “module”) in the recovered program 503 shown in FIG. 5B. The details about a call of the function will be described below.

In step 404, after the operation based on the called function is completed, as shown in FIG. 5C, an area 504 where the recovered program 503 existed is erased by, for example, filling the area 504 with the value 0.

Steps 401 through 404 are performed by the MPU 102 based on an instruction from a non-concealed program 500 (FIGS. 5A through 5C) in the control program.

When the recovery processing in step 402 is completely performed by software, there is a danger that the concealed program 317 may be decrypted by analyzing a portion of the software performing the recovery processing. According to the present invention, such a danger is avoided by the data scramble circuit 103 being included in the device 100. The data scramble circuit 103 is hardware which is specific to the device 100. Unless the knowledge of the hardware which only the developer of the device 100 can know is leaked, the concealed program 317 cannot be decrypted by any person other than the developer.

Hereinafter, a method for calling the function will be described. FIG. 6 is a diagram illustrating a structure of the recovered program 503 recovered from the concealed program 317.

The recovered program 503 includes a relative address list 60 and a program portion 66. The program portion 66 includes public functions 61 and 62 which are called from the outside of the recovered program 503 (i.e., the non-concealed program 500 in FIGS. 5A, 5B and 5C) and internal functions 63, 64 and 65 which are called from the inside of the recovered program 503 using the relative addresses. For example, the public functions 61 and 62 are called from the non-concealed program 500. The public function 61 calls the internal functions 63 and 64 using the relative addresses, and the public function 62 calls the internal functions 63 and 65 using the relative addresses. The number of the internal functions called by each public function is an arbitrary integer.

The relative address list 60 includes the relative addresses of the public functions 61 and 62 viewed from the top of the recovered program 503. Information on the addresses does not rely on the location of the recovered program 503 relative to the rewritable memory 105 in FIG. 5B, and can be obtained from linking information when the program source 311 as the subject of concealment is linked in step 302 (FIG. 3).

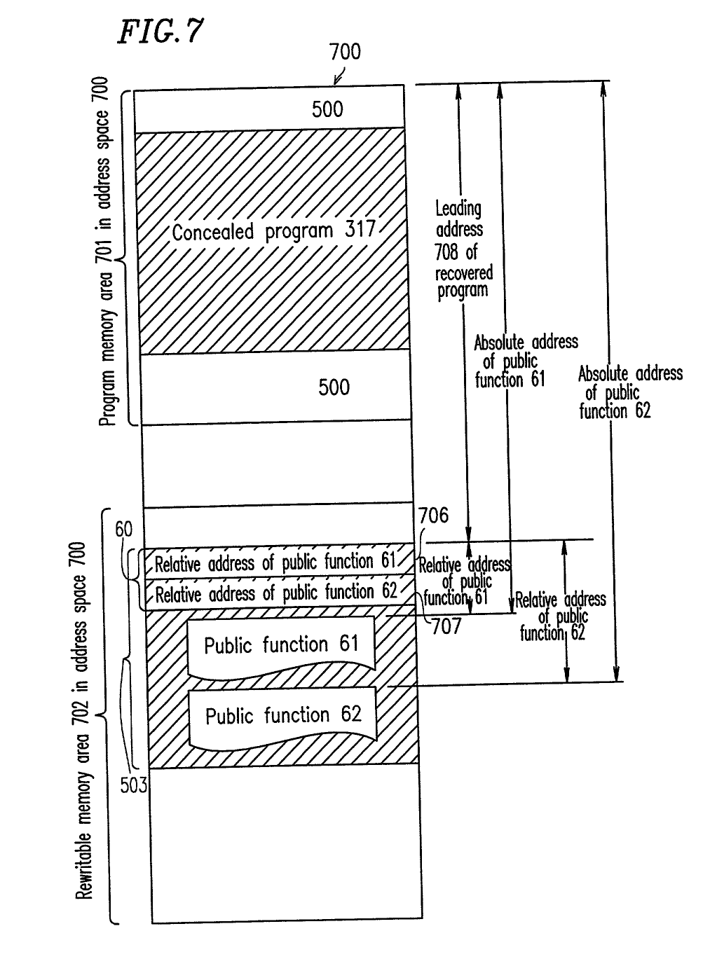

FIG. 7 shows an address space 700 as accessed by the MPU 102 (FIG. 1). The address space 700 includes a program memory area 701 and a rewritable memory area 702. In the address space 700, the program memory 104 and the rewritable memory 105 are respectively located in regions 701 and 702 assigned with specific addresses. The recovered program 503 is recovered to be located at a prescribed address specified by the MPU 102. In the address space 700, the recovered program 503 is located from an address 708 (i.e., the address 708 is the leading address of the recovered program 503). In a leading part of the recovered program 503, the relative address list 60 is located. The relative address list 60 includes a relative address 706 of the public function 61 and a relative address 707 of the public function 62.

The absolute address of the public function 61 in the address space 700 is found by adding the relative address 706 of the public function 61 to the leading address 708 of the recovered program 503. Accordingly, the MPU 102 can call the public function 61 by specifying the absolute address of the public function 61 in the address space 700. The public function 62 can be called in a similar manner.

The relative address list 60 of the recovered program 503 shown in FIG. 7 is located at the leading address of the recovered program 503. The present invention is not limited to this, and the relative address list 60 can be located at a prescribed address which is agreed on by the recovered program 503 and the non-concealed program 500 (FIG. 5A, 5B and 5C). For example, the relative address list 60 can be provided at the 100th or the 200th address from the leading address of the recovered program 503. When the relative address list 503 is located at the 100th address from the leading address of the recovered program 503, the MPU 102 (FIG. 1) can refer to the relative address list 60 by adding 100 to the leading address 708 of the recovered program 503.

As described above, according to the present invention, a control program including a concealed program can be created, and the control program can be safely recovered and executed. The recovery algorithm of the control program is performed partially by hardware embedded in the device and partially by the control program itself. Therefore, even a person who develops a very sophisticated software technology cannot decrypt the cryptograph merely by analyzing the control program. Hardware used (specifically, the data scramble circuit) can have a sufficient resistance against decryption of the cryptograph even though a configuration thereof is simple. Accordingly, the method for decryption according to the present invention is superior in terms of a developing period, cost and security to a method of performing the recovery processing of the concealed program in the control program within hardware or software alone.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A control program for controlling an operation of a microprocessor, the control program comprising a concealed program recoverable by a data scramble circuit and a non-concealed program.

2. A control program according to claim 1, wherein a recovered program recovered from the concealed program includes:
at least one function; and
a relative address list indicating a relative address of the at least one function in the recovered program,
wherein the relative address list is provided at a prescribed location in the recovered program.

3. A device, comprising:
a microprocessor;
a program memory for storing a control program for controlling an operation of the microprocessor, the control program including a concealed program and a non-concealed program;
a rewritable memory for storing a concealed program copied from the concealed program stored in the program memory; and
a data scramble circuit for recovering the concealed program stored in the rewritable memory as a recovered program.

4. A device according to claim 3, wherein the data scramble circuit acts as an error correction circuit.

5. A device according to claim 3, wherein the recovered program includes:
at least one function; and
a relative address list indicating a relative address of the at least one function in the recovered program,
wherein the relative address list is provided at a prescribed location in the recovered program.

6. A method for creating a control program, comprising:
a program descramble step of descrambling a portion of a control program by reverse scramble of a data scramble circuit in a device to be controlled, thereby creating a concealed program as a portion of the control program; and
a program storing step of storing the control program including the concealed program in a program memory so that the control program controls an operation of a microprocessor in the device to be controlled.

7. A method for creating a control program according to claim 6, wherein the program descramble step includes the steps of:
creating a non-concealed program; and
synthesizing the concealed program and the non-concealed program into the control program.

8. A method for operating a control program, comprising:
a program copying step of copying a concealed program which is a portion of the control program from a program memory into a rewritable memory;
a program recovery step of recovering the concealed program copied by the program copying step as a recovered program by a data scramble circuit; and
a program execution step of executing a non-concealed program included in the control program and the recovered program.

9. A method for operating a control program according to claim 8, further comprising a program erasure step of erasing the recovered program from the rewritable memory.
